(19) United States
(12) Patent Application Publication
(10) Pub. No.: US 2014/0089973 A1
(43) Pub. Date: Mar. 27, 2014

(54) NETWORK SERVICE SYSTEM AND METHOD FOR PROVIDING NETWORK SERVICE THEREOF

(71) Applicant: WISTRON CORPORATION, New Taipei City (TW)

(72) Inventor: Yu-Ping Yeh, New Taipei City (TW)

(73) Assignee: WISTRON CORPORATION, New Taipei City (TW)

(21) Appl. No.: 13/706,361

(22) Filed: Dec. 6, 2012

(30) Foreign Application Priority Data
Sep. 21, 2012 (TW) 101134823

(51) Int. Cl. H04N 21/47

(52) U.S. Cl. CPC H04N 21/47
USPC 725/38

(57) ABSTRACT

A method for providing a network service is provided, which is adapted to a network service system including a first network terminal, at least one second network terminal and a network server. The first network terminal logins the network server by using an authorized account through the Internet. The network server provides a network service menu to the first network terminal according to the authorized account. The first network terminal receives a selecting operation from a user. The selecting operation includes a selection of an application service in the network service menu and a selection of the at least one second network terminal for performing the application service. The network server receives content of the application service transmitted from a content provider, and transmits the content to one or more second network terminals.

### CROSS-REFERENCE TO RELATED APPLICATION

This application claims the priority benefit of Taiwan application serial no. 101134823, filed on Sep. 21, 2012. The entirety of the above-mentioned patent application is hereby incorporated by reference herein and made a part of this specification.

### BACKGROUND

1. Technical Field

The invention relates to a network service system. Particularly, the invention relates to a network service system implementing input control through a portable electronic device.

2. Related Art

A smart television (TV) capable of connecting the Internet (which is also referred to as an Internet protocol TV (IPTV)) gradually becomes popular in the market, which provides the users more and more diversified context of use, for example, multimedia on demand (MOD) or video on demand (VOD), etc.

However, regarding most of the current smart TVs, remotes are still used for operations. As the context of use is diversified, people feel it is inconvenient to perform selection, manipulation and input through the remote, especially a menu operation after connecting the Internet. Particularly, it is more difficult to perform character input and selection through the remote.

An input device such as a mouse, a keyboard or a touch panel can be connected through a wired or wireless manner to control the smart TV. Regardless of the wired or wireless manner, the user has to spend money to purchase the input device and the user is limited by an effective range between the input device and the smart TV. Therefore, it is not welcomed by the consumers.

Another method is to use a sound control and a gesture control to replace the keyboard and mouse, by which a sound or image capturing hardware device has to be added to the smart TV. Moreover, regarding the sound or gesture control, a satisfactory correct recognition rate is not yet reached. Therefore, it is necessary to provide a simple method to implement input control operations of the smart TV, so as to cope with the diversified context of use.

### SUMMARY

Accordingly, the invention is directed to a network service system and a method for providing a network service, by which a user uses a portable electronic device that is easy to implement an input operation to control a smart TV.

One aspect of the invention provides a method for providing a network service, which is adapted to a network service system including a first network terminal, at least one second network terminal and a network server. According to the method, the first network terminal logins the network server by using an authorized account through the Internet. The network server provides a network service menu to the first network terminal according to the authorized account. The first network terminal receives a selecting operation from a user, where the selecting operation includes a selection of an application service in the network service menu and a selection of the at least one second network terminal used for executing the application service. The network server receives content of the application service transmitted by a content provider, and transmits the content to the at least one second network terminal.

Another aspect of the invention provides a network service system including a network server, a first network terminal and at least one second network terminal, where the network server, the first network terminal and the at least one second network terminal are all connected to the Internet. The first network terminal logins the network server by using an authorized account. The network server provides a network service menu to the first network terminal according to the authorized account. The first network terminal receives a selecting operation from a user, where the selecting operation includes a selection of an application service in the network service menu and a selection of the at least one second network terminal used for executing the application service. The network server receives content of the application service transmitted by a content provider, and transmits the content to the at least one second network terminal.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a network service system according to an embodiment of the invention.

FIG. 2 is a block diagram of a network service system according to an embodiment of the invention.

FIG. 3 is a flowchart illustrating a method for providing a network service according to an embodiment of the invention.

FIG. 4 is a flowchart illustrating a method for providing a network service according to another embodiment of the invention.

### DETAILED DESCRIPTION OF DISCLOSED EMBODIMENTS

Along with widespread of portable electronic devices such as smart phones and tablet personal computers (PCs), etc., a user usually carries the smart phone or the tablet PC around. Since these portable electronic devices have a simple and easy-to-operate user interface and a networking function, one embodiment of the invention provides the smart phone or the tablet PC to implement the input control function, so as to control one or a plurality of other network terminals (for example, an interne protocol television (IPTV), etc.) connected to a same network server through connections of the network server. Embodiments are provided below to describe the invention in detail, though the provided embodiments are only used for descriptions, and are not used to limit the invention.

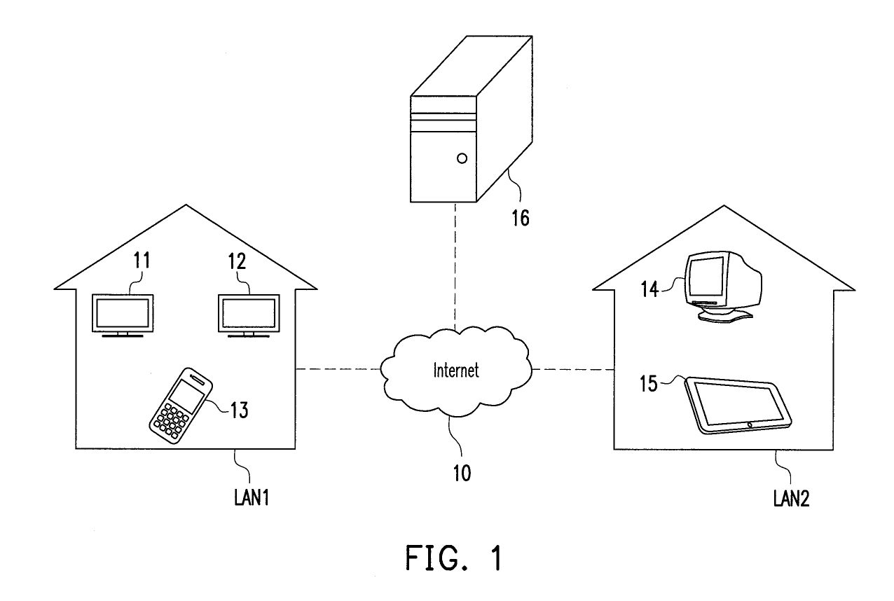

FIG. 1 is a schematic diagram of a network service system according to an embodiment of the invention. Referring to FIG. 1, in the network service system of the present embodiment, an IPTV 11, an IPTV 12, a smart phone 13, a desktop computer 14 and a tablet PC 15 are connected to a network server 16 in the cloud through the Internet 10. In the present embodiment, the IPTV 11, the IPTV 12 and the smart phone 13 are, for example, in a same local area network LAN1, and the desktop computer 14 and the tablet PC 15 are in another local area network LAN2.

The IPTV 11, the IPTV 12, the smart phone 13, the desktop computer 14 and the tablet PC 15 respectively login the network server 16 by using an account respectively, and the network server 16 obtains device information of various network terminals, network service functions and authorization scopes of the network terminals through a network protocol. In other words, the network server 16 is used to manage and control execution of various application services in different network terminals.

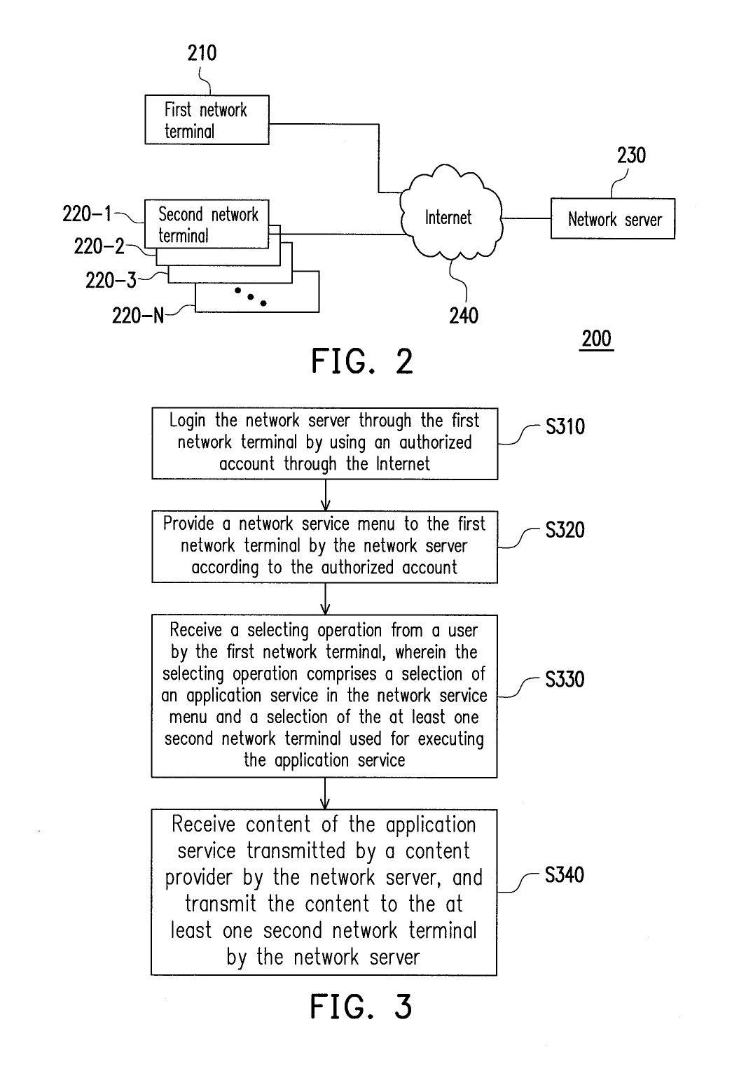

FIG. 2 is a block diagram of a network service system according to an embodiment of the invention. Referring to FIG. 1 and FIG. 2, the network service system 200 of the present embodiment includes a first network terminal 210, second network terminals 220-1, 220-2, 220-3, . . . , 220-N and a network server 230, where N is a positive integer, and functions of the above various components are described below.

The network server 230 is, for example, a server configured at the end of a TV program provider or a server established in home by the user, which can be used to manage various network terminals, or provide a plurality of application services through the Internet 240, where the application services includes digital multimedia services such as a video on demand service, a network game service and a network community service, etc., though the invention is not limited thereto.

The first network terminal 210 is, for example, a portable electronic device such as a smart phone, a tablet PC, a personal digital assistant, an electronic reader, a notebook computer, etc., that has a network connecting function, which logins the network server 230 by using an account through the Internet 240, so as to select the application service provided by the network server 230. The first network terminal 210 at least has an input control function required for executing the application service.

The second network terminals 220 is, for example, an electronic device having a network connection function such as an IPTV, a projector, an audio device, or a speaker, etc., which logins the network server 230 by using an account through the Internet 240, so as to execute the application service delivered by the network server 230. The second network terminal 220 has at least one of the following functions: a video playing function, a video decoding function, a video content providing function and a video communication function.

FIG. 3 is a flowchart illustrating a method for providing a network service according to an embodiment of the invention. Referring to FIG. 2 and FIG. 3, the method of the present embodiment is adapted to the network service system 200 of FIG. 2, and detailed steps of the method of the embodiment are described below with reference of various components of FIG. 2.

In step S310, the first network terminal 210 logins the network server 230 by using an authorized account and/or password of a user through the Internet.

The network server 230 provides a network service menu to the first network terminal 210 according to the authorized account. In step S320, the network server 230 determines device information and a corresponding device function thereof and an authorized scope of the authorized account and lists the application services that can be accessed by the first network terminal 210 as the network service menu. Since the digital multimedia services such as the video on demand service, the network game service and the network community service, etc. are generally paid by the user, application service terminals that can be accessed by the network terminals are not the same. In the present embodiment, the first network terminal 210 at least has the input control function required for executing the application service.

In step S330, after the first network terminal 210 receives the network service menu, it receives a selecting operation from the user. The network service menu is, for example, a browser page or other user interface provided by the network server 230, through which the user can select an application service to be used from the network service menu and select one or a plurality of second network terminals used for executing the application service. For example, if the user selects the video on demand service, the user has to simultaneously select one or a plurality of second network terminals capable of executing the video decoding function and the video playing function.

In step S340, the network server 230 receives content of the application service transmitted by a content provider, and transmits the content to the one or a plurality of second network terminals selected by the user. For example, the content provider (or referred to as a service provider) is an electronic device providing the video content, which can be the network 230 itself, or can be one of the second network terminals 220-1˜220-N.

Since the first network terminal 210 has the input control function required for executing the application service, it is assumed that the first network terminal 210 selects the video on demand service, i.e. the first network terminal 210 can execute the control functions such as fast forward, pause/play, fast backward, volume adjustment, etc. Namely, the network server 230 receives the input control command of the first network terminal 210, and transmits the content of the video on demand service to the second network terminal selected by the user, and controls the second network terminal to play the video content according to the input control command of the user.

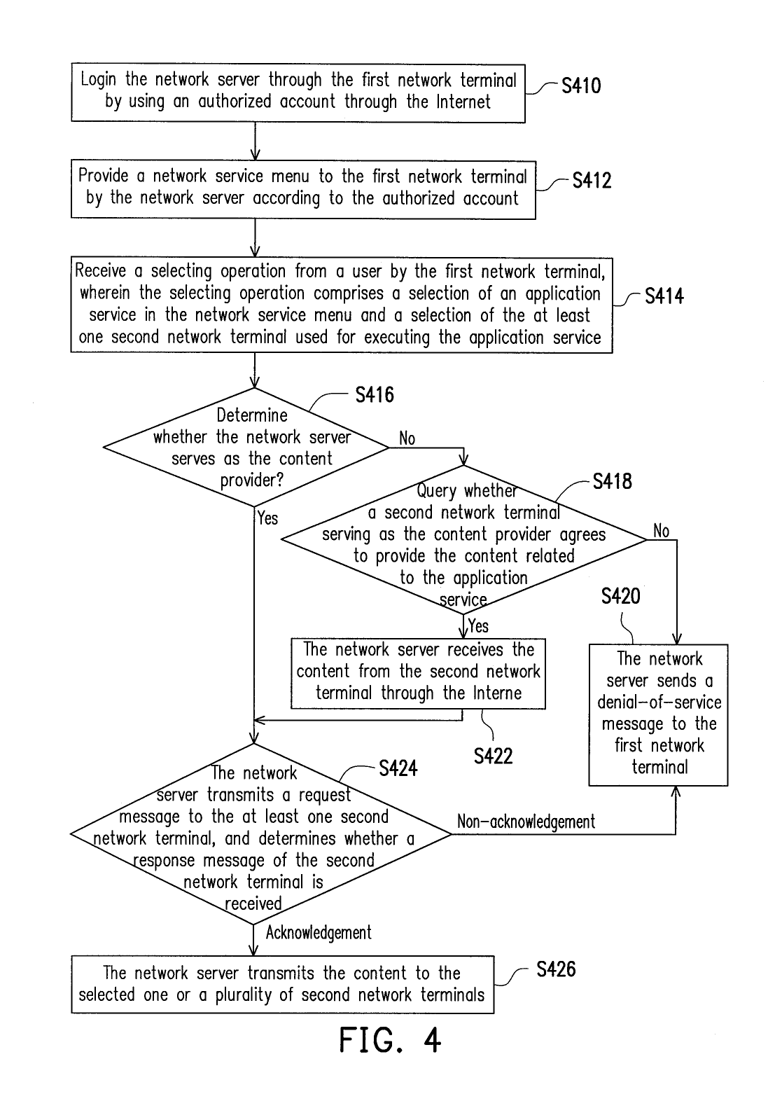

Another embodiment is provided below for further descriptions of the invention. FIG. 4 is a flowchart illustrating a method for providing a network service according to another embodiment of the invention. Referring to FIG. 2 and FIG. 4, the method of the present embodiment is adapted to the network service system 200 of FIG. 2, and detailed steps of the method of the embodiment are described below with reference of various components of FIG. 2.

In step S410, the first network terminal 210 logins the network server 230 by using an authorized account and/or password of a user through the Internet. In step S412, the network server 230 provides a network service menu to the first network terminal 210 according to the authorized account, and lists the application services that can be accessed by the first network terminal 210 as the network service menu. In step S414, the first network terminal 210 receives a selecting operation from the user, where the selecting operation includes a selection of an application service in the network service menu and a selection of one or a plurality of second network terminals used for executing the application service. Implementations of the above steps S410-S414 are similar to that of the steps S310-S330 of the aforementioned embodiment, so that details thereof are not repeated.

Different to the aforementioned embodiment, in the present embodiment, in step S416, the network service system 200 determines whether the network server 230 serves as a content provider. If not, in the step S418, it represents that the content related to the application service has to be provided by another second network terminal, and the network server 230 queries whether the second network terminal that serves as the content provided agrees to provide the content related to the application service. If the second network terminal does not agree, in the step S420, the network server 230 sends a denial-of-service message to the first network terminal 210 to inform the first network terminal 210 that the application service cannot be executed. If the second network terminal agrees to provide the content, in the step S422, the network server 230 receives the content related to the application service from the second network terminal.

Then, in the step S424, the network server 230 transmits a request message to the one or a plurality of second network terminals that are selected to execute the application service, and determines whether a response message is received from the aforementioned second network terminal. The request message, for example, includes querying whether the user of the second network terminal agrees to receive and execute the content of the application service, or includes payment information required for receiving the content. If the network server 230 receives an acknowledgement (ACK) message transmitted by the second network terminal, in the step S426, the network server 230 transmits the content to the selected one or a plurality of second network terminals. Conversely, if the network server 230 receives a non-acknowledgement (NACK) message transmitted by the second network terminal, it represents that the user of the second network terminal does not agree to execute the application service or does not willing to pay. Therefore, the step S420 is executed, and the network server 230 sends the denial-of-service message to the first network terminal 210 to inform the first network terminal 210 that the selected application service cannot be executed. In another embodiment, if the second network terminal does not login the network server 230, the network server 230 can first retain the request message, and again makes the query after the second network terminal logins the network server 230.

Application examples are provided below to describe the invention in detail with reference of FIG. 1 and FIG. 2.

The network terminals 11-15 shown in FIG. 1 first login the network server 16 by executing an authentication procedure, and the network server 16 obtains the device information, the network service functions and the authorization scopes of the network terminals 11-15.

In the present embodiment, the first network terminal 210 is, for example, the smart phone 13 shown in FIG. 1, and after the smart phone 13 logins the network server 16 by using the authorized account and/or password, the network server 16 lists the application services that can be accessed by the smart phone 13 as the network service menu. For example, the smart phone 13 can access the video on demand service to watch multimedia videos such as movies and TV programs, etc. Therefore, a user U1 of the smart phone 13 can use a user interface of the smart phone 13 to select the video to be watched, and request the IPTV 11 to play.

In the present embodiment, the network server 16 is, for example, a TV or a server established by other multimedia practitioner, i.e. the network server 16 can provide the video content to be viewed by the user. Therefore, the network server 16 transmits the request message to the selected second network terminal (i.e. the IPTV 11), where the request message, for example, includes payment information required for viewing such video content. In an embodiment, if the IPTV 11 does not login the network server 16, the network server 16 retains the request message, and again makes the query after the IPTV 11 is connected to the Internet and logins the network server 16. In another embodiment, after the user U1 of the IPTV 11 (the same to the user of the smart phone 13) transmits the ACK message to the network server 16, the network server 16 transmits the selected video content to the IPTV 11 to play. In this way, the user U1 can execute the control functions such as fast forward, pause/play, fast backward, volume adjustment, etc. of the IPTV 11 through the input control function of the smart phone 13.

It should be noticed that besides that the user U1 controls the network server 16 through the smart phone 13 to transmit the selected video content to the IPTV 11 or the IPTV 12 located in the same local area network LAN1 to play, the user U1 can also share the selected video content to the desktop computer 14 or the tablet PC 15 in the other local area network LAN2 through the smart phone 13. It should be noticed that before the network server 16 transmits the video content to the desktop computer 14 or the tablet PC 15, it first determines whether the desktop computer 14 or the tablet PC 15 has a network video playing function, a network video decoding function, or a network video communication function. Moreover, only when a user U2 of the desktop computer 14 or the tablet PC 15 agrees to play the video content, the network server 16 transmits the video content to the desktop computer 14 or the tablet PC 15.

In summary, the network service system and the method for providing the network service of the invention can manage the application services of a plurality of network terminals through the network server, and a portable electronic device having a simple and easy-to-operate user interface and a networking function such as a smart phone or a tablet PC, etc., can be used to quickly implement the input control function, so as to control one or a plurality of network terminals connected to the same network server to execute the required application service.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for providing a network service, adapted to a network service system comprising a first network terminal, at least one second network terminal and a network server, and the method comprising:
logining the network server by the first network terminal by using an authorized account through the Internet;
providing a network service menu to the first network terminal by the network server according to the authorized account;
receiving a selecting operation from a user by the first network terminal, wherein the selecting operation comprises a selection of an application service in the network service menu and a selection of the at least one second network terminal used for executing the application service; and
receiving content of the application service transmitted from a content provider by the network server, and transmitting the content to the at least one second network terminal by the network server.

2. The method as claimed in claim 1, further comprising:
confirming whether the network server serves as the content provider;
directly transmitting the content to the at least one second network terminal by the network server when the network server serves as the content provider; and
querying whether a second network terminal serving as the content provider agrees to provide the content by the network server when the network server is not the content provider.

3. The method as claimed in claim 2, further comprising:
receiving the content from the second network terminal through the Internet by the network server when the second network terminal serving as the content provider agrees to provide the content; and
sending a denial-of-service message to the first network terminal by the network server when the second network terminal serving as the content provider does not agree to provide the content.

4. The method as claimed in claim 1, wherein before the step of transmitting the content to the at least one second network terminal by the network server, the method further comprises:
transmitting a request message to the at least one second network terminal by the network server, and determining whether the network server receives a response message from the at least one second network terminal;
transmitting the content to the at least one second network terminal by the network server when the network server receives an acknowledgement message from the at least one second network terminal; and
transmitting a denial-of-service message to the first network terminal by the network server when the network server receives a non-acknowledgement message from the at least one second network terminal.

5. The method as claimed in claim 1, wherein the application service comprises at least one of a network video service, a network game service and a network community service.

6. The method as claimed in claim 1, wherein the first network terminal has an input control function for executing the application service.

7. The method as claimed in claim 1, wherein the at least one second network terminal has at least one of a video playing function, a video decoding function, a video content providing function and a video communication function.

8. A network service system, comprising:
a network server, connected to the Internet;
a first network terminal, connected to the Internet, and logining the network server by using an authorized account; and
at least one second network terminal, connected to the Internet,
wherein the network server provides a network service menu to the first network terminal according to the authorized account, the first network terminal receives a selecting operation from a user, wherein the selecting operation comprises a selection of an application service in the network service menu and a selection of the at least one second network terminal used for executing the application service, and the network server receives content of the application service transmitted by a content provider, and transmits the content to the at least one second network terminal.

9. The network service system as claimed in claim 8, wherein when the network server serves as the content provider,
the network server directly transmits the content of the application service to the at least one second network terminal.

10. The network service system as claimed in claim 8, wherein when the network server is not the content provider,
the network server queries whether a second network terminal serving as the content provider agrees to provide the content,
when the second network terminal agrees to provide the content, the network server receives the content from the second network terminal through the Internet, and
when the second network terminal does not agree to provide the content, the network server sends a denial-of-service message to the first network terminal.

11. The network service system as claimed in claim 8, wherein
the network server further transmits a request message to the at least one second network terminal, and determines whether a response message of the at least one second network terminal is received, wherein when an acknowledgement message is received, the network server transmits the content to the at least one second network terminal, and when a non-acknowledgement message is received, the network server transmits a denial-of-service message to the first network terminal.

12. The network service system as claimed in claim 8, wherein the application service comprises at least one of a network video service, a network game service and a network community service.

13. The network service system as claimed in claim 8, wherein the first network terminal has an input control function for executing the application service.

14. The network service system as claimed in claim 8, wherein the at least one second network terminal has at least one of a video playing function, a video decoding function, a video content providing function and a video communication function.

1. A method for providing a network service, adapted to a network service system comprising a first network terminal, at least one second network terminal and a network server, and the method comprising:
logining the network server by the first network terminal by using an authorized account through the Internet;
providing a network service menu to the first network terminal by the network server according to the authorized account;
receiving a selecting operation from a user by the first network terminal, wherein the selecting operation comprises a selection of an application service in the network service menu and a selection of the at least one second network terminal used for executing the application service, wherein the application service is a network video service; and
receiving video content of the application service transmitted from a content provider by the network server, and transmitting the video content to the at least one second network terminal by the network server,
transmitting an input control command of the user by the first network terminal, wherein the at least one second network terminal plays the video content according to the input control command of the user.

2. The method as claimed in claim 1, further comprising:
confirming whether the network server serves as the content provider;
directly transmitting the content to the at least one second network terminal by the network server when the network server serves as the content provider; and
querying whether a second network terminal serving as the content provider agrees to provide the content by the network server when the network server is not the content provider.

3. The method as claimed in claim 2, further comprising:
receiving the content from the second network terminal through the Internet by the network server when the second network terminal serving as the content provider agrees to provide the content; and
sending a denial-of-service message to the first network terminal by the network server when the second network terminal serving as the content provider does not agree to provide the content.

4. The method as claimed in claim 1, wherein before the step of transmitting the content to the at least one second network terminal by the network server, the method further comprises:
transmitting a request message to the at least one second network terminal by the network server, and determining whether the network server receives a response message from the at least one second network terminal;
transmitting the content to the at least one second network terminal by the network server when the network server receives an acknowledgement message from the at least one second network terminal; and
transmitting a denial-of-service message to the first network terminal by the network server when the network server receives a non-acknowledgement message from the at least one second network terminal.

5. The method as claimed in claim 1, wherein the application service comprises at least one of a network game service and a network community service.

6. (canceled)

7. The method as claimed in claim 1, wherein the at least one second network terminal has at least one of a video playing function, a video decoding function, a video content providing function and a video communication function.

8. A network service system, comprising:
a network server, connected to the Internet;
a first network terminal, connected to the Internet, and logining the network server by using an authorized account;
at least one second network terminal, connected to the Internet,
wherein the network server provides a network service menu to the first network terminal according to the authorized account, the first network terminal receives a selecting operation from a user, wherein the selecting operation comprises a selection of an application service in the network service menu and a selection of the at least one second network terminal used for executing the application service, wherein the application service is a network video service, and the network server receives video content of the application service transmitted by a content provider, and transmits the video content to the at least one second network terminal,
wherein the first network terminal transmits an input control command of the user to the network server, and the at least one second network terminal plays the video content according to the input control command of the user.

9. The network service system as claimed in claim 8, wherein when the network server serves as the content provider,
the network server directly transmits the content of the application service to the at least one second network terminal.

10. The network service system as claimed in claim 8, wherein when the network server is not the content provider,
the network server queries whether a second network terminal serving as the content provider agrees to provide the content,
when the second network terminal agrees to provide the content, the network server receives the content from the second network terminal through the Internet, and
when the second network terminal does not agree to provide the content, the network server sends a denial-of-service message to the first network terminal.

11. The network service system as claimed in claim 8, wherein
the network server further transmits a request message to the at least one second network terminal, and determines whether a response message of the at least one second network terminal is received, wherein when an acknowledgement message is received, the network server transmits the content to the at least one second network terminal, and when a non-acknowledgement message is received, the network server transmits a denial-of-service message to the first network terminal.

12. The network service system as claimed in claim 8, wherein the application service comprises at least one of a network game service and a network community service.

13. The network service system as claimed in claim 8, wherein the first network terminal has an input control function for executing the application service.

14. The network service system as claimed in claim 8, wherein the at least one second network terminal has at least one of a video playing function, a video decoding function, a video content providing function and a video communication function.
